(19) United States
(12) Patent Application Publication
(10) Pub. No.: US 2006/0073874 A1
(43) Pub. Date: Apr. 6, 2006

(54) Gaming device having random generation of values and mathematical operations performed on the values

(76) Inventors: Karen M. Cregan, Reno, NV (US); Anthony J. Baerlocher, Reno, NV (US)

Correspondence Address: Bell, Boyd & Lloyd LLC, P.O. Box 1135, Chicago, IL, 60690-1135, US

(21) Appl. No.: 10/956,253

(22) Filed: Oct. 1, 2004

(51) Int. Cl. A63F 13/00

(52) U.S. Cl. 463/20

(57) ABSTRACT

A gaming machine including wagering base game or a bonus game is provided. In one embodiment, values are generated via player selection or automatically. Additional selections are presented to the player. The player picks the selections, which direct the values into groups. One of the selections results (i) in a termination of play and (ii) a mathematical operation that is used to combine the groups of values to form an award for the player.

### BACKGROUND OF THE INVENTION

Gaming devices provide enjoyment and excitement to players, in part, because they may ultimately lead to monetary awards for the players. Gaming devices also provide enjoyment and excitement to players because they are fun to play. Bonus games, in particular, provide gaming device manufacturers with the opportunity to add enjoyment and excitement to that which is already expected from a base game of the gaming device. Bonus games provide extra awards to the player and enable the player to play a game that is different than the base game.

Gaming devices are typically games of luck, not skill. They are configured to pay back a certain percentage of the amount of money inputted into the machine. The payout percentage in most wagering games is set high enough that any player who plays a few hands or spins of the reels wins. That is, in most wagering games it is not too difficult to experience some level of success.

Bonus games are typically configured for the player to succeed and are factored into the overall paytable of the wagering game accordingly. The player usually wins an award in a bonus game. In bonus game play, the goal is often to maximize the possible award. Winning, at least on some level, is therefore a standard component in gaming devices. Moreover, the payout percentage of any gaming device is ultimately set by the relevant gaming jurisdiction and gaming establishment, not the game designer.

A continuing need therefore exists to provide gaming devices that issue awards in an exciting and enjoyable manner. In this respect, it is desirable to enable the player to have an impact on, or a hand in, determining their award. It is further desirable to increase the level of player interaction. Each of those features is desirable in the base wagering game a primary or secondary game. Accordingly, a need exists for the further development of wagering games having the above-described features and advantages.

### SUMMARY OF THE INVENTION

The present invention in one primary embodiment provides a bonus game that operates in combination with a wagering base game, such as slot, poker, keno, blackjack, craps, bingo, checkers and the like. In one embodiment, multiple incrementing meters are used in combination with a outcome generation display device, such as a wheel or reel. In one embodiment, the outcome generation display device is electromechanical and located at a first portion of the gaming device, while the incrementing meters are provided on a video monitor, which is located at a second portion of the gaming device. In this manner, the two outputs of the game, values and which meter is incremented can be determined at the same or substantially the same time.

The player actuates or causes actuation of the outcome generation device such as the wheel, which generates a value or outcome, such as a number of credits. The player then picks a selection from a plurality of selections. The picked selection yields a symbol indicative of one of a plurality of incrementing meters displayed to the player, such as a symbol A designating an A meter as opposed to a B or C meter. Any suitable number of meters may be provided. The value or outcome is added to or used to increment the generated meter.

The selection of values or outcomes repeats or continues in the manner until the player exhaust all provided spins or activations of the outcome generation display device. In one embodiment, the player is provided spins or activations until one of the selections yields a terminator. The terminator in one embodiment also yields a mathematical operation, such as multiplication or addition. The generated operation is used to combine the total values accumulated in at least two of the meters. For example, if two meters are provided and incremented during game play and the terminator ultimately yields an addition operation, the values of the two meters are added together to form an overall award for the player. In another example, the terminator yields a multiplication operation and the values of the two meters are multiplied together to form an overall award for the player. In a further example, three meters are incremented until the terminator yields an addition and a multiplication operation, after which the values of the three meters are added and multiplied together according to a preset protocol such as multiplication first and addition second, to form an overall award for the player.

In one embodiment, the selections are placed in rounds and the player receives a preset number of picks from each round, e.g., one pick from each round. The selections yield outcomes, such as outcomes incrementing one of the meters (e.g., meter A), more than one meter (e.g., meters A and B out of A, B and C), or all meters (e.g., meters A, B and C out of A, B and C). The rounds in one embodiment increase the likelihood of termination as the rounds advance. In the final round, only terminators are generated. Here, the player hopes the termination yields the most lucrative mathematical operation, e.g., multiplication as opposed to addition.

In another primary embodiment, the selections are provided in a selection grid and the player makes a preset number of (i) picks of the selections and (ii) spins of the outcome generation device or wheel. Each of the selections yields a mathematical operation, which becomes associated with a value generated from the outcome generation display device. After each of the picks of the selections is made, an equation having at least two values and one mathematical operation is formed. The player's award in one embodiment is the result of the equation.

It is therefore an advantage of the present invention to provide a fun and exciting slot machine, poker or keno bonus game.

Another advantage of the present invention is to provide a bonus game having a fun and exciting display.

A further advantage of the present invention is to provide a game that can be played on a video monitor and a separate electromechanical display.

Yet another advantage of the present invention is to provide a wagering game with multiple random elements.

Still a further advantage of the present invention is to provide a wagering game that provides player inputs performing different functions, such as (i) the generation of values and (ii) the placement of the values into different groups.

Additional features and advantages of the present invention are described in, and will be apparent from, the following Detailed Description of the Invention and the figures.

### BRIEF DESCRIPTION OF THE FIGURES

FIG. 1A is a front perspective view of one embodiment of the gaming device of the present invention.

FIG. 1B is a front perspective view of another embodiment of the gaming device of the present invention.

FIG. 2A is a schematic block diagram of one embodiment of an electronic configuration for one of the gaming devices of the present invention.

FIG. 2B is a schematic block diagram of one embodiment of a network configuration for a plurality of gaming devices of the present invention.

FIG. 3 is an elevation view of one of the display devices of the gaming machine showing one example of an outcome generation display device of the present invention.

FIG. 4 is an elevation view of one of the display devices of the gaming machine showing another example of an outcome generation display device of the present invention.

FIGS. 5, 6, 7, 8, 9 and 10 illustrate one example of the multiple incrementing meter wagering game of one embodiment of the present invention.

FIG. 11 illustrates one alternative selection grid of one embodiment of the present invention.

FIG. 12 illustrates one revealed selection grid of one embodiment of the present invention.

FIGS. 13, 14, 15 and 16 illustrate a game play example of one alternative embodiment of the present invention.

FIG. 17 illustrates a non-exhaustive list of different mathematical operation combinations for the embodiments of FIGS. 13 to 16.

### DETAILED DESCRIPTION OF THE INVENTION

### The Gaming Device Generally

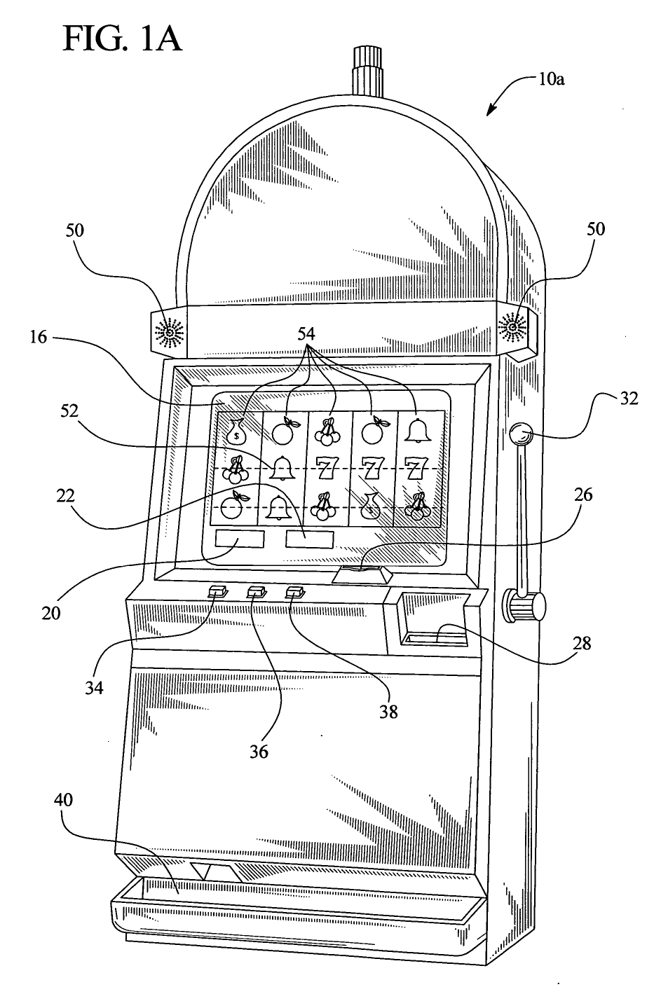

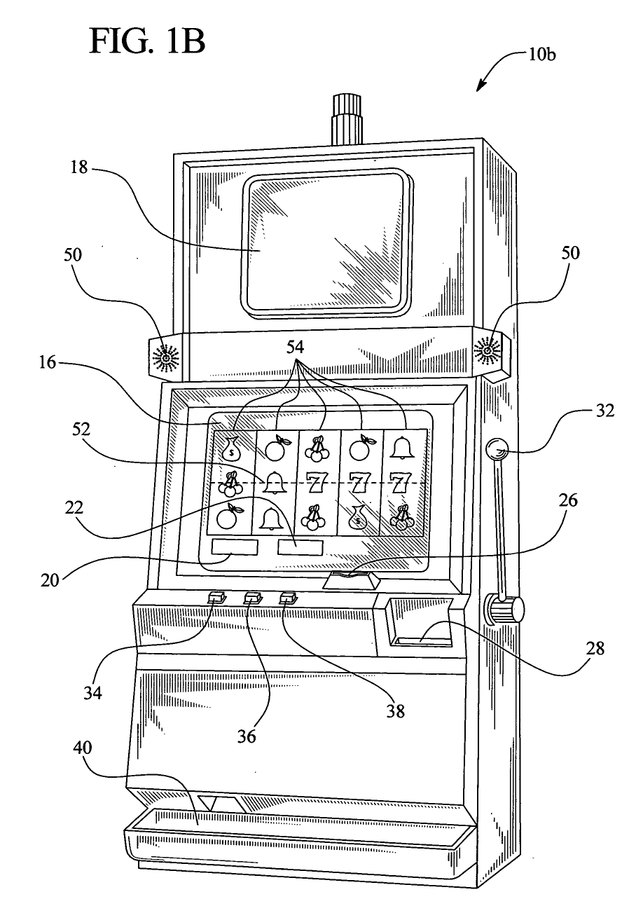

Referring now to the drawings, two alternative embodiments of the gaming device of the present invention are illustrated in FIGS. 1A and 1B as gaming device 10a and gaming device 10b, respectively. Gaming device 10a and/or gaming device 10b are generally referred to herein as gaming device 10.

In one embodiment, as illustrated in FIGS. 1A and 1B, gaming device 10 has a support structure, housing or cabinet which provides support for a plurality of displays, inputs, controls and other features of a conventional gaming machine. Gaming device 10 is configured to be operated by a player standing or sitting. The gaming device may be positioned on a base or stand or is configured as a pub-style table-top game (not shown) which a player can operate while sitting. As illustrated by the different configurations shown in FIGS. 1A and 1B, gaming device 10 can be constructed with varying cabinet and display configurations.

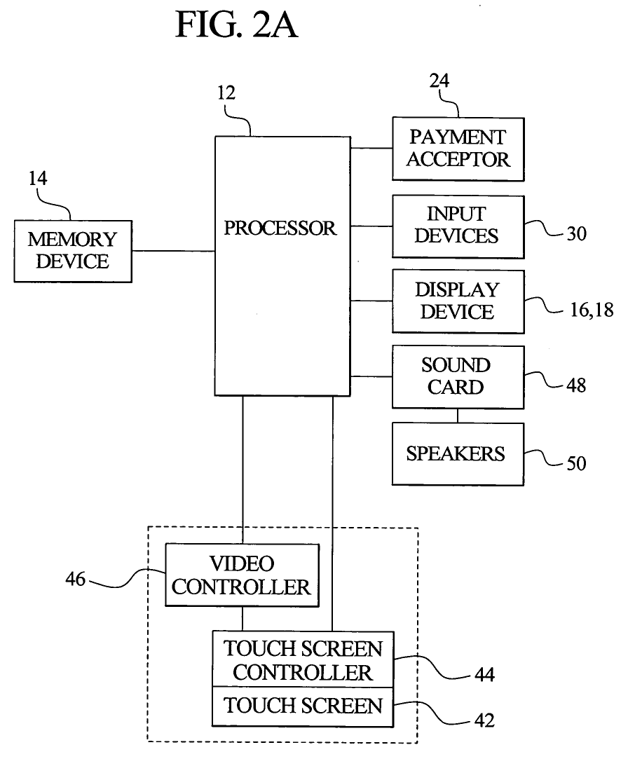

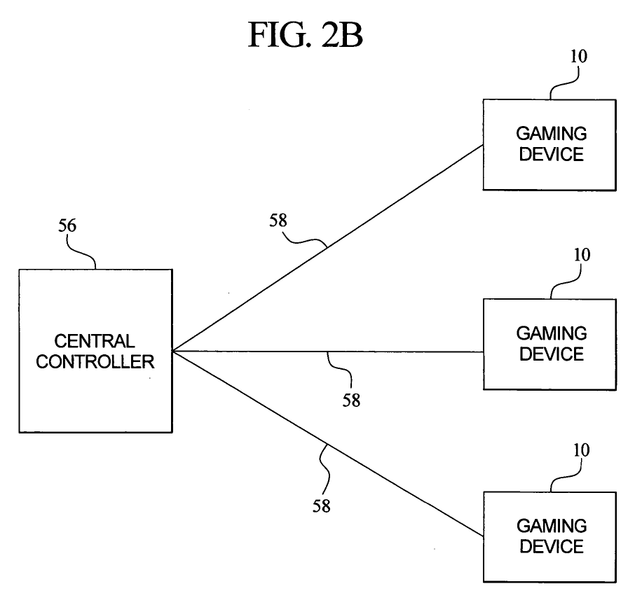

In one embodiment, as illustrated in FIG. 2A, gaming device 10 includes at least one processor 12, such as a microprocessor, a microcontroller-based platform, a suitable integrated circuit or one or more application-specific integrated circuits (ASIC's). Processor 12 is in communication with or operable to access or to exchange signals with at least one data storage or memory device 14. In one embodiment, processor 12 and memory device 14 reside within the cabinet of gaming device 10. The memory device stores program code and instructions, executable by processor 12, to control gaming device 10. Memory device 14 also stores other data such as image data, event data, player input data, random or pseudo-random number generators, pay-table data or other operating data, information and applicable game rules that relate to the play of gaming device 10.

Memory device 14 includes random access memory (RAM) and read only memory (ROM) in one preferred embodiment. Alternatively or additionally, memory device 14 includes flash memory and/or EEPROM (electrically erasable programmable read only memory). Any other suitable magnetic, optical and/or semiconductor memory may be implemented in conjunction with gaming device 10 of the present invention. Processor 12 and memory device 14 may be collectively referred to herein as a “computer” or “controller.”

In one embodiment, part or all of the program code and/or operating data described above can be stored in a detachable or removable memory device, including, but not limited to, a suitable cartridge, disk or CD ROM. A player can use such a removable memory device in a desktop, a laptop personal computer, a personal digital assistant (PDA) or other computerized platform.

In one embodiment, as discussed in more detail below, gaming device 10 randomly generates awards and/or other game outcomes based on probability data. That is, each award or other game outcome is associated with a probability and gaming device 10 generates the award or other game outcome to be provided to the player based on the associated probabilities. In this embodiment, since gaming device 10 generates outcomes randomly or based upon a probability calculation, there is no certainty that gaming device 10 will provide the player with any specific award or other game outcome.

In another embodiment, as discussed in more detail below, gaming device 10 employs a predetermined or finite set or pool of awards or other game outcomes. In this embodiment, as each award or other game outcome is provided to the player, gaming device 10 removes the provided award or other game outcome from the predetermined set or pool. Once removed from the set or pool, the specific provided award or other game outcome cannot be provided to the player again. In this type of embodiment, gaming device 10 provides players with all of the available awards or other game outcomes over the course of the play cycle and guarantees a designated amount of actual wins and losses.

In one embodiment, as illustrated in FIG. 2A, processor 12 of gaming device 10 controls one or more display devices. The display devices are connected to or mounted to the cabinet of gaming device 10. The embodiment shown in FIG. 1A includes a central display device 16 which displays a primary game. This display device may also display any suitable secondary game associated with the primary game as well as information relating to the primary or secondary game. The alternative embodiment shown in FIG. 1B includes a central display device 16 and an upper display device 18. The upper display device may display the primary game, any suitable secondary game associated with the primary game and/or information relating to the primary or secondary game.

The display devices may include, without limitation, a monitor, a television display, a plasma display, a liquid crystal display (LCD), a display based on light emitting diodes (LED) or any other suitable electronic device or display mechanism. In one embodiment, as described in more detail below, the display device includes a touchscreen with an associated touchscreen controller. The display devices may be of any suitable configuration, such as a square, a rectangle or an elongated rectangle.

The display devices of gaming device 10 are configured to display at one or a plurality of games or other suitable images, symbols and indicia such as any visual representation or exhibition of the movement of objects such as mechanical, virtual or video reels and wheels, dynamic lighting, video images and images of people, characters, places, things and faces of cards, tournament advertisements, promotions and the like.

In one alternative embodiment, the symbols, images and indicia displayed on or by the display device may be in mechanical or electromechanical form. That is, the display device may include any suitable electromechanical device which moves one or more mechanical objects, such as one or more mechanical rotatable wheels or reels that each display at least one image, symbol or indicia.

As seen in FIGS. 1A and 1B, in one embodiment gaming device 10 includes a credit display 20 which displays a player's current number of credits, cash, account balance or the equivalent. In one embodiment, gaming device 10 includes a bet display 22 which displays a player's amount wagered.

As illustrated in FIG. 2A, in one embodiment, gaming device 10 includes at least one payment acceptor 24 in communication with processor 12. As seen in FIGS. 1A and 1B, the payment acceptor may include a coin slot 26 and a payment, note or bill acceptor 28, where the player inserts money, coins or tokens. The player can place coins in the coin slot or paper money, ticket or voucher into the payment, note or bill acceptor. In other embodiments, devices such as readers or validators for credit cards, debit cards, data cards or credit slips could be used for accepting payment.

As seen in FIGS. 1A, 1B and 2A, in one embodiment gaming device 10 includes at least one input device 30 that communicates with processor 12. Input devices 30 can include any suitable apparatus that enables the player to produce an input signal which is read by the processor. In one embodiment, after appropriate funding of gaming device 10, the input device is a game activation device, such as a pull arm 32 or a play button 34 which is used by the player to start any primary game or sequence of events in gaming device 10. The play button can be any suitable play activator such as a bet one button, a max bet button or a repeat the bet button. In one embodiment, upon appropriate funding, gaming device 10 begins the game play automatically. In another embodiment, upon the player engaging one of the play buttons, gaming device 10 automatically activates game play.

In one embodiment, as shown in FIGS. 1A and 1B, one input device is a bet one button 36. The player places a bet by pushing bet one button 36. The player can increase the bet by one credit each time the player pushes bet one button 36. When the player pushes the bet one button, the number of credits shown in credit display 20 decreases by one, and the number of credits shown in bet display 22 increases by one. In another embodiment, one input device 30 is a bet max button (not shown) that enables the player to bet the maximum wager permitted for a game associated with gaming device 10.

Gaming device 10 also includes a cash out button 38. The player may push cash out button 38 and cash out to receive a cash payment or other suitable form of payment corresponding to the number of remaining credits. In one embodiment, when the player cashes out, the player receives the coins or tokens in a coin payout tray 40. In another embodiment, when the player cashes out, the player receives another type of payout mechanism such as a tickets or credit slips, which are redeemable by a cashier or funded to the player's electronically recordable identification card.

As mentioned above and seen in FIG. 2A, a touchscreen 42 may be provided that couples with a touchscreen controller 44, or some other touch-sensitive display overlay to allow the player to interact with the images on the display. The touchscreen and the touchscreen controller are connected to a video controller 46. A player can make decisions and input signals into gaming device 10 by touching the touchscreen at the appropriate places.

Gaming device 10 may further include a plurality of communication ports for enabling communication of the processor with external peripherals, such as external video sources, expansion buses, game or other displays, an SCSI port or a key pad.

In one embodiment, as seen in FIG. 2A, gaming device 10 includes a sound generating device controlled by one or more sounds cards 48 which function in conjunction with the processor. In one embodiment, the sound generating device operates with at least one speaker 50 or other sound generating hardware and/or software for generating sounds, such as playing music for the primary and/or secondary game or for other modes of gaming device 10, such as an attract mode. Gaming device 10 can provide dynamic sounds coupled with attractive multimedia images displayed on one or more of the display devices to provide an audio-visual representation or to otherwise display full-motion video with sound to attract players to gaming device 10. During idle periods, gaming device 10 may display a sequence of audio and/or visual attraction messages to attract potential players to gaming device 10. The videos may also be customized for or to provide any appropriate information.

In one embodiment, the gaming machine may include a player or other sensor, such as a camera in communication with the processor (and possibly controlled by the processor) that is selectively positioned to acquire an image of a player actively using gaming device 10 and/or the surrounding area of gaming device 10. In one embodiment, the camera may be configured to selectively acquire still or moving (e.g., video) images and may be configured to acquire the images in either an analog, digital or other suitable format. The display device may be configured to display the image acquired by the camera as well as display the visible manifestation of the game in split screen or picture-in-picture fashion. For example, the camera may acquire an image of the player and that image can be incorporated into the primary and/or secondary game as a game image, symbol or indicia.

Gaming device 10 can incorporate any suitable wagering primary or base game. The gaming machine or device of the present invention may include some or all of the features of conventional gaming machines or devices. The primary or base game may comprise any suitable reel-type game, card game, number game or other game of chance susceptible to representation in an electronic or electromechanical form which produces a random outcome based on probability data upon activation of the game from a wager made by the player. That is, different primary wagering games, such as video poker games, video blackjack games, video keno, video bingo or any other suitable primary or base game may be implemented into the present invention. As described below, the present invention operates at least with the base games of slot and poker.

### Slot Base Game Generally

In one embodiment, as illustrated in FIGS. 1A and 1B, a base or primary game may be a slot game with one or more paylines 52. The paylines may be horizontal, vertical, circular, diagonal, angled or any combination thereof. In this embodiment, gaming device 10 displays at least one reel 54, such as three to five reels, in either electromechanical form with mechanical rotating reels or in video form with simulated reels and movement thereof. In one embodiment, an electromechanical slot machine includes a plurality of adjacent, rotatable wheels which may be combined and operably coupled with an electronic display of any suitable type. In another embodiment, if the reels are in video form, the plurality of simulated video reels are displayed on one or more of the display devices as described above.

Each reel displays a plurality of indicia such as bells, hearts, fruits, numbers, letters, bars or other images that correspond to a theme associated with gaming device 10. In this embodiment, gaming device 10 awards prizes when the reels of the primary game stop spinning if specified types and/or configurations of indicia or symbols occur on an active pay line or otherwise occur in a winning combination or pattern.

As seen above in FIGS. 1A and 1B display devices 16 or 18 display a plurality of reels 54. Reels 54 operate with a plurality of five paylines 52 in one embodiment, such as five paylines 52. In addition to credit display 20, bet display 22 and play button 34, display device 16 or 18 can also displays the number of paylines as well as a bet per payline. Gaming device 10 also provides input devices that enable the player to change the number of paylines wagered and bet per payline, respectively.

### Poker Base Game Generally

In one embodiment, a base or primary game may be a poker game wherein gaming device 10 enables the player to play a conventional game of video poker and initially deals five cards, all face up, from a virtual deck of fifty-two cards. As seen in FIGS. 12 to 14, playing cards may be dealt to positions 94a to 94c as in a traditional game of cards or in the case of gaming device 10, the cards may be randomly selected from a predetermined number of cards. If the player wishes to draw, the player selects the cards to hold by using one or more input devices, such as pressing related hold buttons or touching a corresponding area on a touchscreen. After the player presses the deal button, processor 12 of gaming device 10 removes the unwanted or discarded cards from the display and deals replacement cards from the remaining cards in the deck. This results in a final five-card hand. The processor of gaming device 10 compares the final five-card hand to a payout table which utilizes conventional poker hand rankings to determine the winning hands. An award based in an embodiment on the credits wagered is provided to the player upon a winning hand.

In another embodiment, the base or primary game may be a multi-hand version of video poker. In this embodiment, the player is dealt at least two hands of cards. In one such embodiment, the cards in all of the dealt hands are the same cards. In one embodiment each hand of cards is associated with its own deck of cards. The player chooses the cards to hold in a primary hand. The held cards in the primary hand are also held in the other hands of cards. The remaining non-held cards are removed from each displayed hand and replaced with randomly dealt cards. Since the replacement cards are randomly dealt independently for each hand, the replacement cards will usually be different for each hand. The poker hand rankings are then determined hand by hand and awards are provided to the player.

### Keno

In one embodiment, a base or primary game may be a keno game wherein gaming device 10 displays a plurality of selectable indicia or numbers on at least one of the display devices. In this embodiment, the player selects at least one and preferably a plurality of the selectable indicia or numbers by using an input device or by using the touchscreen. Gaming device 10 then displays a series of drawn numbers to determine an amount of matches, if any, between the player's selected numbers and the gaming device's drawn numbers. The player is provided an award, if any, based on the amount of determined matches.

### Bonus Game

In one embodiment, in addition to winning credits in a base or primary game, the gaming device may also give players the opportunity to win credits in a bonus or secondary game or bonus or secondary round. The bonus or secondary game enables the player to obtain a bonus prize or payout in addition to the prize or payout, if any, obtained from the base or primary game. In general, a bonus or secondary game produces a significantly higher level of player excitement than the base or primary game because it provides a greater expectation of winning than the base or primary game and is accompanied with more attractive or unusual features than the base or primary game.

In one embodiment, gaming device 10 includes a program code that causes processor 12 to automatically begin a bonus round when the player has achieved a triggering event, a qualifying condition or other designated game event in the base or primary game, which can be a particular arrangement of one or more indicia occurring on a display device in the primary game (e.g., the number seven appearing on three adjacent reels along a payline 52 in the primary slot game embodiment seen in FIGS. 1A and 1B). Entering the bonus round may also require a threshold wagering amount, such as max lines, max wager per payline or maximum total wager.

In one embodiment, once a player has qualified for a bonus game, the player may subsequently enhance their bonus game participation by returning to the base or primary game for continued play. Thus, for each bonus qualifying event, such as a bonus symbol, that the player obtains, a given number of bonus game wagering points or credits may be accumulated in a “bonus meter” programmed to accrue the bonus wagering credits or entries towards eventual participation in a bonus game. The occurrence of multiple bonus qualifying events in the primary game may result in an arithmetic or geometric increase in the number of bonus wagering credits awarded. In one embodiment, extra bonus wagering credits may be redeemed during the bonus game to extend play of the bonus game.

In one embodiment, no separate entry fee or buy in for a bonus game need be employed. That is, a player may not purchase an entry into a bonus game. The player must win or earn entry through play of the primary game, thereby encouraging play of the primary game. In another embodiment, qualification of the bonus or secondary game could be accomplished through a simple “buy in” by the player if, for example, the player has been unsuccessful at qualifying for the bonus game through other specified activities.

### Server Controlled Gaming Devices

In one embodiment, as illustrated in FIG. 2B, one or more of the gaming devices 10 of the present invention may be connected to a data network or a remote communication link 58 with some or all of the functions of each gaming device provided at a central location such as a central server or central controller 56. More specifically, processor 12 of each gaming device may be designed to facilitate transmission of signals between the individual gaming device and the central server or controller.

In one embodiment, the game outcome provided to the player is determined by central server or controller 56 and provided to the player at gaming device 10 of the present invention. In this embodiment, each of a plurality of such gaming devices 10 are in communication with the central server or controller 56. Upon a player initiating game play at one of the gaming devices, the initiated gaming device communicates a game outcome request to the central server or controller 56.

In one embodiment, central server or controller 56 receives the game outcome request and randomly generates a game outcome for the primary game based on probability data. In another embodiment, the central server or controller 56 randomly generates a game outcome for the secondary game based on probability data. In a further embodiment, the central server or controller 56 randomly generates a game outcome for both the primary game and the secondary game based on probability data. In this embodiment, the central server or controller 56 is capable of storing and utilizing program code or other data similar to processor 12 and memory device 14 of gaming device 10.

In an alternative embodiment, the central server or controller 56 maintains one or more predetermined pools or sets of predetermined game outcomes. In this embodiment, the central server or controller 56 receives the game outcome request and independently selects a predetermined game outcome from a set or pool of game outcomes. The central server or controller 56 flags or marks the selected game outcome as used. Once a game outcome is flagged as used, it is prevented from further selection from the set or pool and cannot be selected by the central controller or server 56 upon another wager. The provided game outcome can include a primary game outcome, a secondary game outcome, primary and secondary game outcomes, or a series of game outcomes, such free games.

The central server or controller 56 communicates the generated or selected game outcome to the initiated gaming device 10. Gaming device 10 receives the generated or selected game outcome and provides the game outcome to the player. In an alternative embodiment, how the generated or selected game outcome is to be presented or displayed to the player, such as a reel symbol combination of a slot machine or a hand of cards dealt in a card game, is also determined by the central server or controller 56 and communicated to the initiated gaming device to be presented or displayed to the player. Central production or control can assist a gaming establishment or other entity in maintaining appropriate records, controlling gaming, reducing and/or preventing cheating or electronic or other errors, reducing or eliminating win-loss volatility and the like.

In another embodiment, one or more of the gaming devices of the present invention are in communication with a central server or controller 56 for monitoring purposes only. That is, each individual gaming device 10 randomly generates the game outcomes to be provided to the player and the central server or controller 56 monitors the activities and events occurring on the plurality of gaming devices. In one embodiment, the gaming network includes a real-time or an on-line accounting and gaming information system operably coupled to the central server or controller. The accounting and gaming information system of this embodiment includes a player database for storing player profiles, a player tracking module for tracking players and a credit system for providing automated casino transactions.

A plurality of the gaming devices of the present invention are capable of being connected to a data network. In one embodiment, the data network is a local area network (LAN), in which one or more of the gaming devices are substantially proximate to each other and an on-site central server or controller as in, for example, a gaming establishment or a portion of a gaming establishment. In another embodiment, the data network is a wide area network (WAN) in which one or more of the gaming devices are in communication with at least one off-site central server or controller. In this embodiment, the plurality of gaming devices may be located in a different part of the gaming establishment or within a different gaming establishment than the off-site central server or controller. Thus, the WAN may include an off-site central server or controller and an off-site gaming device located within gaming establishments in the same geographic area, such as a city or state. The WAN gaming system of the present invention may be substantially identical to the LAN gaming system described above, although the number of gaming devices in each system may vary relative to each other.

In another embodiment, the data network is an internet or intranet. In this embodiment, the operation of gaming device 10 can be viewed at the gaming device with at least one internet browser. In this embodiment, operation of gaming device 10 and accumulation of credits may be accomplished with only a connection to the central server or controller 56 (the internet/intranet server or webserver) through a conventional phone or other data transmission line, digital signal line (DSL), T-1 line, coaxial cable, fiber optic cable, wireless gateway or other suitable connection. In this embodiment, players may access an internet game page from any location where an internet connection and computer, or other internet facilitator are available. The expansion in the number of computers and number and speed of internet connections in recent years increases opportunities for players to play from an ever-increasing number of remote sites. It should be appreciated that enhanced bandwidth of digital wireless communications may render such technology suitable for some or all communications according to the present invention, particularly if such communications are encrypted. Higher data transmission speeds may be useful for enhancing the sophistication and response of the display and interaction with the player.

In another embodiment, a plurality of gaming devices 10 at one or more gaming sites may be networked to a central server 56 in a progressive configuration, as known in the art, wherein a portion of each wager to initiate a base or primary game may be allocated to bonus or secondary event awards. In one embodiment, a host site computer is coupled to a plurality of the central servers 56 at a variety of mutually remote gaming sites for providing a multi-site linked progressive automated gaming system. In one embodiment, a host site computer may serve gaming devices distributed throughout a number of properties at different geographical locations including, for example, different locations within a city or different cities within a state.

In one embodiment, the host site computer is maintained for the overall operation and control of the system. In this embodiment, a host site computer oversees the entire progressive gaming system and is the master for computing all progressive jackpots. All participating gaming sites report to, and receive information from, the host site computer. Each central server computer 56 is responsible for all data communication between gaming device 10 hardware and software and the host site computer.

### Game with Awards Formed from Generated Values and Mathematical Operations

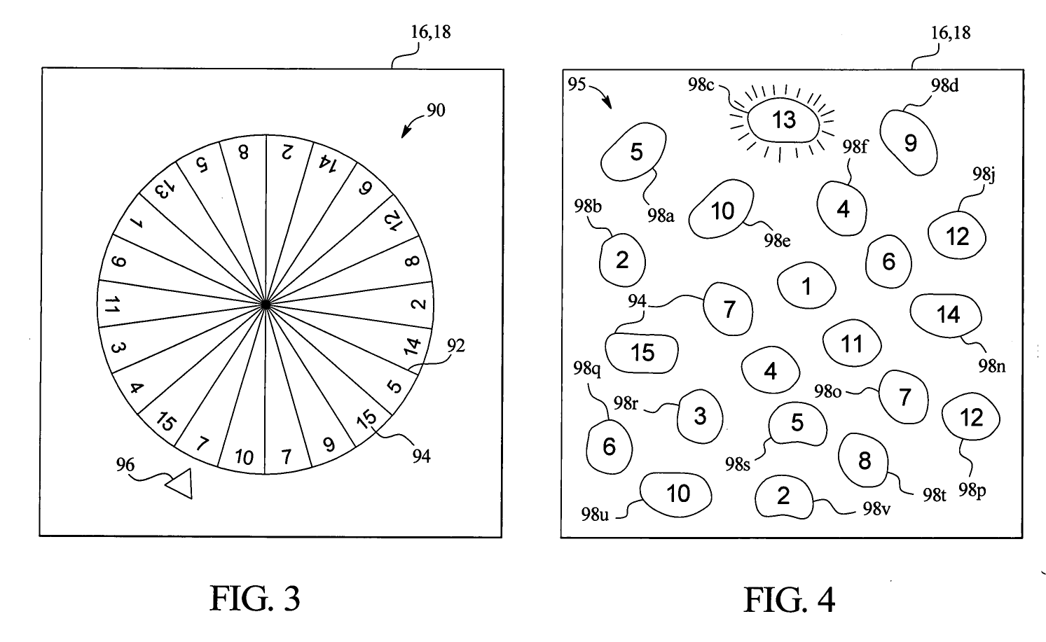

Referring now to FIGS. 3 and 4, various embodiments for determining values used in the game of the present invention are illustrated. The values may be randomly generated or generated in any other suitable manner. One example of a generation device has been discussed above in connection with FIGS. 1A and 1B, namely, one or more spinning reels may be used to generate values. Likewise, the game in the following description can also use simulated or electromechanical reels to generate symbols or values. The displays in FIGS. 3 and 4 can display outcomes determined randomly by processor 12 of gaming device 10 or centrally central server or controller 56 discussed in connection with FIG. 2B.

FIG. 3 illustrates an alternative embodiment, which employs a spinning wheel 90. Spinning wheel 90 is displayed on one of the display areas 16 or 18. For example, spinning wheel 90 can be simulated on the video monitor of lower display area 16 shown in FIGS. 1A and 1B. Alternatively, spinning wheel 90 is a mechanical or electromechanical wheel provided in upper display area 18. Further alternatively, spinning wheel 90 is simulated on a video monitor provided at upper display area 18.

Wheel 90 spins about a central axis as is well known. Wheel 90 includes a series of wedges or sections 92 that divide and distinguish a plurality of values 94. In the illustrated embodiment, wheel 90 includes twenty-two wedges or sections 92. The twenty-two wedges display values one to fifteen. It should be appreciated that any suitable number of wedges 92 and values 94 may be provided. A pointer or indicator 96 is located adjacent to spinning wheel 90. After wheel 90 spins in one or more directions and stops, indicator 96 indicates one of the values 94. That indicated value is used in the sequence described below.

FIG. 4 illustrates another alternative outcome display 95. Display 95 includes a plurality of display areas 98a to 98v. Display areas 98a to 98v correspond to the twenty-two wedges or sections 92 of spinning wheel 90. Alternatively, a different number of display areas 98 (referring collectively to display areas 98a to 98v, etc.) are provided. Values 94 are generated in display areas 98a to 98v. One of the values 94 is designated for the player in its corresponding display area 98 via any suitable audio, visual or audio-visual indication. As illustrated, display area 98c currently highlights the value thirteen via illumination.

In one embodiment, display areas 98 of display 95 are dedicated to a particular value 94. The values and associated display areas are sequentially highlighted until a designated value is eventually highlighted. Alternatively, the values appear sequentially in different ones of the display areas 98 until eventually one of the values 94 is designated, via the illumination, highlighting or other suitable modes of indication. In another example, the values 94 are selectively masked until only the designated value 94 is shown. It should be appreciated that those of skill in the art can employ other ways to display the values, besides spinning reels, spinning wheels and selective highlighting.

The values 94 generated via any of the above-described mechanisms 90 and 95 and associated methods are useable with any of the embodiments described below.

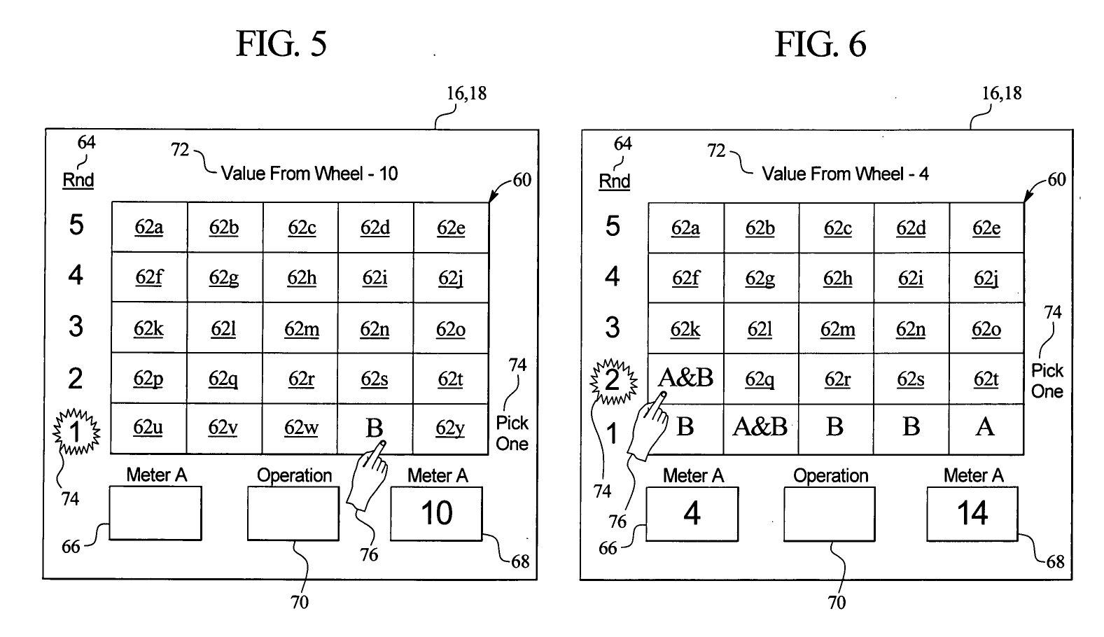

Referring now to FIGS. 5 to 12, one embodiment of the present invention is illustrated. In general, this embodiment includes a game in which player's selections control meters that increment from values generated by a generation device (such as the generation devices illustrated in FIG. 3 or 4) to form an overall award or outcome for the player. The illustrated example uses two meters 66 and 68. It should be appreciated, however that any suitable number of incrementing meters may be employed while the player picks the selections. The selections yield whether a value 94 displayed by the outcome generation display devices (e.g., FIGS. 3 and 4) is placed in a first and/or second one of the meters 66 or 68.

The player in one embodiment picks a selection from a plurality of a sequentially played groups or rounds of selections until the player picks a selection that yields a game termination outcome or terminator. When the player picks a terminator, the terminator in one embodiment also reveals a mathematical operation. The mathematical operation includes any one or more of the mathematical operations selected from addition, subtraction, multiplication, division, any combination of these operations, or any other suitable mathematical formula. The generated mathematical operation is then applied to the values accumulated in the at least two meters 66 and 68 to form an overall award for the player.

FIG. 5 illustrates a first selection round and one implementation of the wagering game of the present invention, which is displayed on one of the display devices 16 or 18. In one embodiment, the screen of FIG. 5 is displayed after the player receives a bonus triggering event in a base wagering game, such as slot. In a bonus game, the sequence in FIGS. 5 to 10 generally provides a net overall gain of credits to the player. In another embodiment, the screen of FIG. 5 appears after the player deposits the appropriate amount of funds in the gaming device to play a wagering game as a primary wagering game. If the sequence of FIGS. 5 to 10 is a primary or base game, the player may or may not win credits.

FIG. 5 illustrates an array or grid 60 of selections 62 (referring collectively to selections 62a to 62y or generally to one of the selections). In an embodiment, selections 62 are displayed on a video monitor that operates with the touchscreen 42, touchscreen controller 44, video controller 46 and processor 12, discussed above. In one embodiment, the selection grid 60 is displayed on a video monitor located in the lower display area 16, while the values are generated on an electromechanical output generation device located in the upper display area 18, such as an electromechanical wheel. Alternatively, grid 60, meters 66 and 68 and the outcome display device 90 or 95.

Selection grid 60 is divided into a plurality of rounds 64 highlighted on the left side of the selection grid 60. In the illustrated embodiment, selections 62a to 62e are part of round five; selections 62f to 62j are part of round four; selections 62k to 62o are part of round three; selections 62p to 62t are part of round two; and selections 62u to 62y are part of round one.

FIG. 5 also illustrates the plurality of incrementing award value meters 66 and 68. Meters 66 and 68 increment values according to the outcomes of the selections picked by the player. A mathematical operation display 70 is placed between meters 66 and 68. Eventually, one of the selections yields a mathematical operation, which is then shown in display 70. The operation in one embodiment is provided in combination with a game termination outcome. The arrangement of meters 66 and 68 and display 70 provides useful information to the player and generally informs the player that the player's overall award will eventually be a combination of the values shown in meters 66 and 68.

The sequence of the game can proceed in a number of ways. In one embodiment, the player (i) presses an input device 30 (FIG. 2A) to initiate, e.g., spin, the outcome generation display device to display a value and then (ii) initiates the meter selection sequence by picking one of the selections 62 from the first available group or round of selections 62. After the player picks the selection, gaming device 10 reveals into which meter the generated value is placed. In another embodiment, the outcome generation display device is player activated or auto-activated to generate the value after the player picks one of the selections 62. Gaming device 10 then places the value in the appropriate meter 66 or 68. In a further alternative embodiment, gaming device 10 auto-initiates the outcome generation display device, which displays one of the values. The value can be auto-generated before or after the player's pick of one of the selections. The values are determined by the processor.

The illustrated embodiment operates according to the first listed operation arrangement, in which the player initiates via an input device 30 (FIG. 2A) spinning wheel 90, the display 95 or other outcome display device, which generates a value. The generated value is displayed in FIG. 5 in combination with audio, visual or audio visual message 72. The player knowing the amount of the value then picks one of the appropriate selections (e.g., from the proper round or group) to determine which meter 66 or 68 receives the generate value.

In FIG. 5, message 72 informs the player that the current value to be allocated is the value ten. That is, spinning wheel 90, display 95, or some other generation display device has generated the value ten. In FIG. 5, suitable audio, visual or audiovisual indicia 74 highlights round one and also prompts the player pick one of the selections 62u through 62y belonging to group or round one. As seen in FIG. 5, a player 76 picks one of the selections 62u to 62y, namely, selection 62x. Selection 62x is revealed in FIG. 5 to show a symbol that indicates which meter 66 or 68 receives the current available value ten. In the illustrated embodiment, selection 62x reveals the letter B, which is associated with meter 68. It should be appreciated that any suitable indicia identifying the corresponding meter can be provided, and in one embodiment is chosen to be consistent with a theme of gaming device 10.

In FIG. 5, the play of round one is completed. The available value is ten, the player picks selection 62x and the selection reveals that the value ten is to be placed in meter 68. Accordingly, meter 68 shows the value ten as opposed to meter 66 which currently has no value or zero value (Meter 66 can alternatively display a zero total).

In the illustrated embodiment, player 76 is able to make one pick from each group or round 64 of selections 62. In an alternative embodiment, player 76 is able to make more than one pick in a round, a variable number of picks in a round, a pick until a certain outcome occurs in a round, an increasing amount of picks in sequential rounds, a decreasing amount of picks in sequential rounds, or any combination thereof.

In FIG. 6, indicia 74 indicates that the player is able to pick one of the selections 62p to 62t in group or round two. Also, each of the selections 62u to 62w and 62y of round one has been revealed to show the player the outcome that would have been received if player 76 had instead picked one of those selections instead of selection 62x. The revealed selections of round one show that a higher selection of B meter outcomes is provided than A meter outcomes. It should be appreciated that any suitable proportion of outcomes may be provided, including not providing an outcome for one of the meters 66 and 68. Further, the outcome in association with selection 62b indicates or designates both meters 66 and 68. If three meters are provided, one of the selections can designate one, two or three of the meters, and so on.

Message 72 indicates that the spinning wheel 90 or device 95 has generated the value four. Player 76 picks selection 62p, which is revealed to show an outcome designating that both meter A and meter B receive the incremental value four. Accordingly, meter 66 is incremented from zero to four and meter 68 is incremented from ten to fourteen. In the illustrated embodiment, the values add within meters 66 and 68. In an alternative embodiment, the values within the meters can be multiplied or incremented variably (e.g., addition in one round and multiplication in another round) to form a new incremented total.

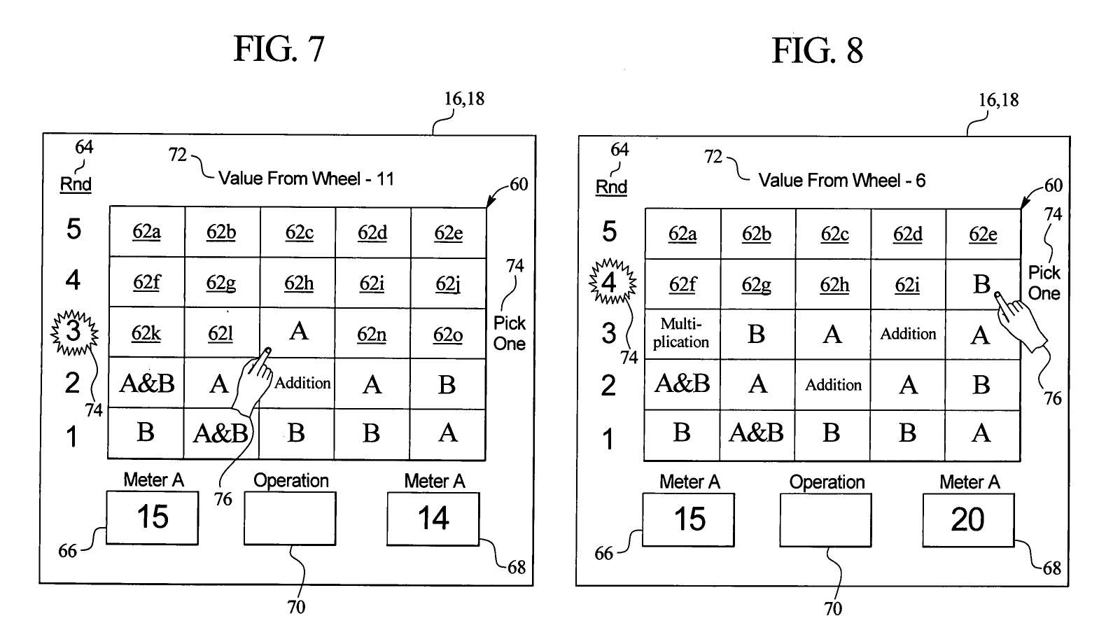

FIG. 7 reveals the outcomes of unselected selections 62q to 62t of round or group 2. As illustrated, a termination outcome is provided in round or group 2. In particular, the mathematical operation of addition is the outcome of selection 62r. That is, if the player had picked selection 62r instead of selection 62p, the addition operation would have been performed upon the total values within meters 66 and 68 in FIG. 5 to form an overall award for the player. In the illustrated embodiment, the outcome of selection 62r serves two purposes: (i) to determine how to combine the values of meter A and meter B and (ii) to signal an end of the player's ability to further increment the values within meters 66 and 68.

FIG. 7 via message 72 shows that the current value generated via one of the generation display devices is the value eleven. As discussed above, gaming device 10 in one embodiment prompts player 76 between rounds to initiate the generation display device, such as wheel 90 or device 95. Such prompting can occur on the same display device 16 or 18 as selection grid 60 or on the same display device 16 or 18 as generation display device, such as wheel 90 or device 95.

In FIG. 7, message 74 indicates to the player that the current round 64 is round three and also encourages player 76 to pick one of the selections 62k through 620. Player 76 accordingly picks selection 62m, which reveals that the generated value eleven is to be added to meter A (meter 66). Accordingly, meter A is incremented from four (as seen in FIG. 6) to fifteen as seen in FIG. 7.

FIG. 8 reveals the remaining outcomes from the outcomes of the selections 62k, 62l, 62n and 62o of round or group three. Round three includes two terminators, namely, a multiplication terminator as an outcome of selection 62k and an addition terminator as an outcome of selection 62n. Round three has more terminators than round two. In an embodiment, the rounds become more difficult to survive as the rounds continue. This provides a game in which the player desires to survive as many rounds as possible, so that meters 66 and 68 are incremented more often.

As seen in FIG. 8, the mathematical operation ultimately displayed in operation meter 70 can be different depending on which selection the player chooses. One operation may be more desirable than another mathematical operation. For example it may be desirable to obtain an addition multiplier in an earlier round in case one of the meters A and B does not have a non-zero total at the time the terminator is selected. In one embodiment, meters A and B begin at one credit so that if the operation in meter 70 is multiplication, the player is guaranteed to receive a non-zero outcome. In later rounds, a multiplier is likely more desirable to the player because the multiplier likely generates a larger overall award or outcome for the player.

Message 72 of FIG. 8 illustrates that a value from the separate outcome generation display device has been generated as the value six. Message 74 indicates that the current round 64 is round four and also informs the player to pick one of the selections 62f through 62j included in group of round four. Accordingly, player 76 picks the selection 62j, which yields a B meter outcome. Accordingly, meter B (meter 68) is incremented by six to twenty.

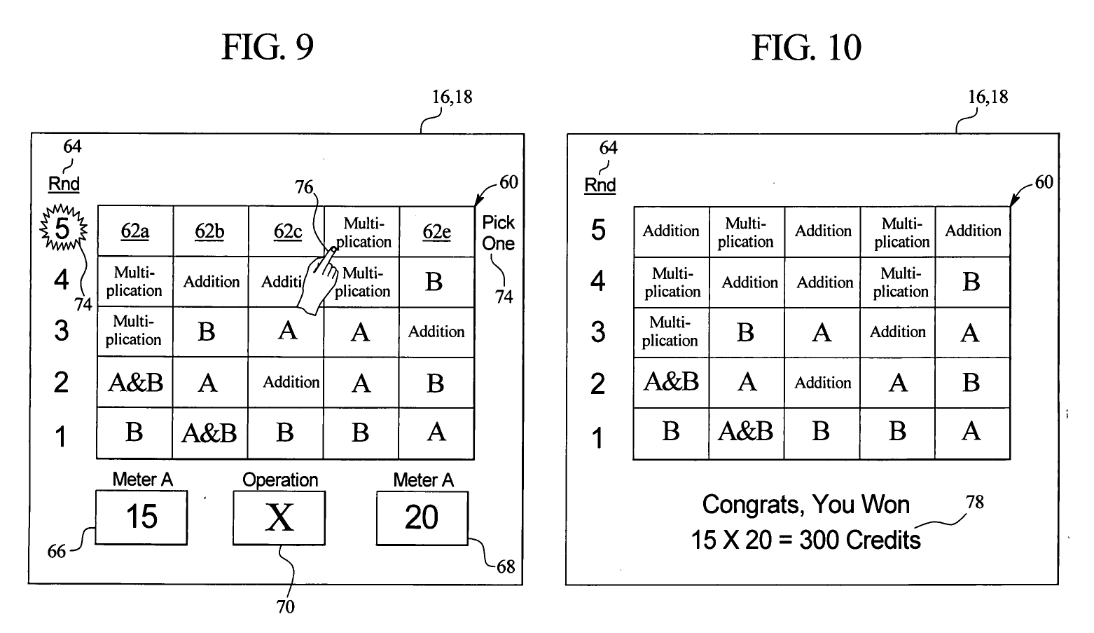

Referring now to FIG. 9, each of the selections for round or group four is revealed. As illustrated, group four includes four terminators and only one non-terminator outcome. Player 76 indeed is lucky to advance through round four to round five. In the illustrated embodiment, the amount of terminators doubles from round two to round three and again from round three to round four. The present invention includes any desirable percentage loading of terminators in the different rounds and any desirable percentage increase or decrease of such terminators in later rounds.

Message 74 of FIG. 9 indicates that the current round 64 is the final round five and encourages the player to pick one of the selections 62a to 62e of round five. In one embodiment, the final round only includes terminators. In such case, gaming device 10 does not need to display another generated value because the player has no chance of accumulating such value. The player at this stage of the game hopes to generate the most valuable mathematical operation, for example, a multiplication terminator as opposed to an addition terminator.

As seen in FIG. 9, player 76 picks selection 62d, which yields a multiplication terminator. Accordingly, a multiplication operator is displayed in mathematical operation display 70. The player's overall award or outcome is then the value accumulated in meter A multiplied by the value accumulated in meter B.

Referring now to FIG. 10, grid 60 is shown fully revealed. The final round included three possible addition outcomes and two possible multiplication outcomes. In the illustrated embodiment, the available terminators are associated with multiplication or addition outcomes. Alternatively, the mathematical operations could include subtraction and division or any other combination of multiplication, addition, subtraction and division, or any other suitable mathematical formula or equation. That is, a mathematical operation displayed in display 70 does not have to employ a single mathematical operator but can instead employ multiple mathematical operators as well as mathematical constants or mathematical equations.

The player's overall award is the accumulated fifteen value from meter 66 multiplied by the accumulated twenty value from meter 68 or 300 credits, as indicated by message 78. As seen in FIG. 10, each of the outcomes from selections 62a to 62e of round five results in a terminator. In an alternative embodiment, an outcome in the final round can send the player back to an earlier round. In such case, the earlier round and any succeeding rounds are not fully revealed or are revealed but are re-shuffled or resorted with masked selections. This alternative embodiment can be used for example when the game is a bonus game as a consolation to a player when the player hits a terminator early on in the game or when the overall award is below a threshold.

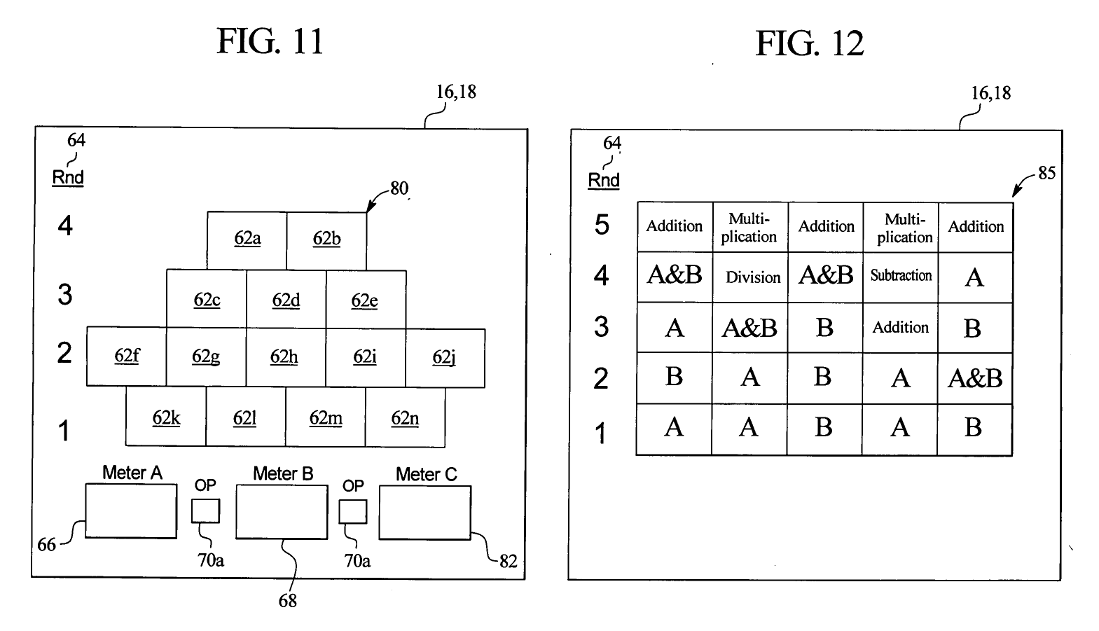

Referring now to FIG. 11, an alternative selection grid 80 is illustrated on one of the display devices 16 or 18. This embodiment includes a four round game as shown by the four rounds 64. Also, grid 80 includes groups or rounds having different amounts of constituent selections. Each group or round of grid 60 on the other hand has the same number of selections per round. The present invention includes (i) providing the same number of selections per round, (ii) providing a different number of selections for at least one round and/or (iii) populating the rounds to produce an overall grid having any desirable profile, such as a bell-like profile of FIG. 11.

The embodiment of FIG. 11 also displays three incrementing meters 66, 68 and 82. The embodiment also includes two mathematical operation displays 70a and 70b. The mathematical operation shown eventually in display 70a is used to combine the accumulated value from meter 66 and meter 68 (or the combination of meter 68 and meter 82). The mathematical operation displayed in display 70b is used to combine the value obtained in meter 68 (or the combination of meter 66 and meter 68) and the value obtained in meter 82. Together, meters A to C and mathematical operations 70a and 70b combine to form an overall equation, which is executed using standard rules of mathematical protocol such as multiplication and division occurring between two values before addition and subtraction between one of those two values and a third value.

Referring now to FIG. 12, a further alternative grid 85 is illustrated fully revealed. Grid 85 illustrates that four different types of mathematical operations are used, namely, multiplication, division, addition and subtraction. In the case of division, the player's award or outcome can be rounded up or down to the nearest whole credit or be paid out in fraction of a credit, depending on the domination of the wager input and the credits employed by gaming device 10. Grid 85 also displays an outcome array having less termination outcomes in earlier rounds than the grid 60 of FIG. 10. The player therefore has a better opportunity to advance all the way to the final round 64 (e.g., round five) in the game of FIG. 12.

### Build an Award Determination Equation

Referring now to FIGS. 13 to 17, another primary embodiment of the present invention is illustrated. The embodiment illustrated in FIGS. 13 to 17 is similar to the other primary embodiment illustrated above. In particular, both primary embodiments employ one or more outcome generation display devices, such as one of those shown in FIGS. 3 and 4. Further, both primary embodiments include a selection grid or plurality of masked selections from which the player picks to determine how the values generated from the separate device(s) are combined mathematically to form an overall award for the player.

FIGS. 13 to 16 illustrate one example of the second primary embodiment of the present invention. In FIG. 13, a selection grid 100 is provided, which includes masked selections 102a through 102j. In this primary embodiment, player 76 does not pick selections through rounds or groups of selections, rather, player 76 picks from the same grouping of selections. The player is provided a number of picks of selections 102 (referring collectively to selections 102a to 102j). To that end, a “picks remaining” display 104 is provided to show the player how many picks of selections 102 remain.

As seen in FIG. 13, player 76 is provided initially with three picks. The number of picks may be preset or variable and based upon any suitable one or more factor, such as (i) a random determination, (ii) an outcome from a base or preliminary game, (iii) the player's wager, (iv) a component of the player's wager, (v) how many games the player has played before playing the instant game, (vi) an amount won or lost, or (vii) any combination thereof.

In FIG. 13, player 76 picks selection 102c which yields a multiplication outcome. Here, mathematical operations do not terminate the game, rather, the operations are associated with a value from the outcome generation display device. To that end, a message 106 informs the player that the current value to be associated with the mathematical operation from the next selection pick is a value ten. Picks remaining display 104 shows the player's picks decrease from three to two.

An interactive display 108 is provided on the screens of FIGS. 13 to 16, which forms and displays to the player an overall mathematical equation including associated values, which is used to form the player's overall award or outcome. Display 108 in FIG. 13 illustrates a first portion of the resulting award equation, namely, that a multiplier has been associated with the generated value ten. In this primary embodiment, as before, the value may be determined randomly or otherwise (i) before or (ii) after player 76 picks one of the selections 102, yielding a mathematical operation that is associated with the determined value. Again, although not illustrated gaming device 10 can prompt the player to initiate the outcome generation display device to generate a value. Alternatively, gaming device 10 auto-generates values for use at the appropriate time.

The illustrated embodiment associates a mathematical operation with each value. In an alternative embodiment, a mathematical operation is associated between each of the values. Thus if four values are generated, three mathematical operations are generated and associated one each between each pair of values.

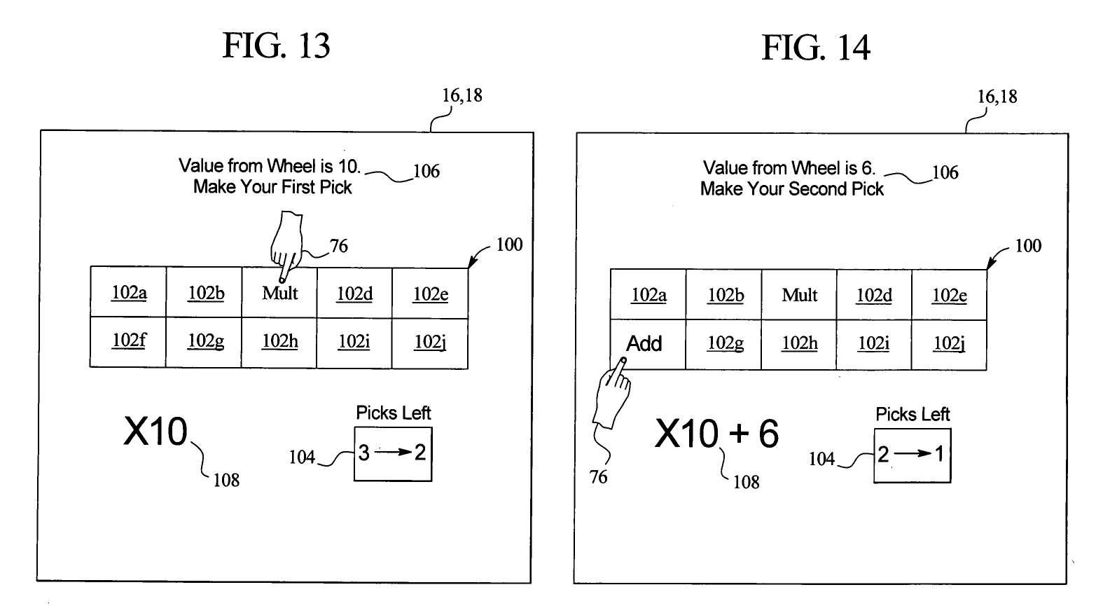

In FIG. 14 player 76 picks selection 102f. Picks remaining display 104 illustrates the player's picks decrease again from two to one. Masked selection 102f is revealed to show an addition operation. The addition operation is associated with the value determined and displayed by the outcome generation display device, which message 106 indicates is the value six. In FIG. 14, interactive display 108 is updated to show a ×10 and a +6.

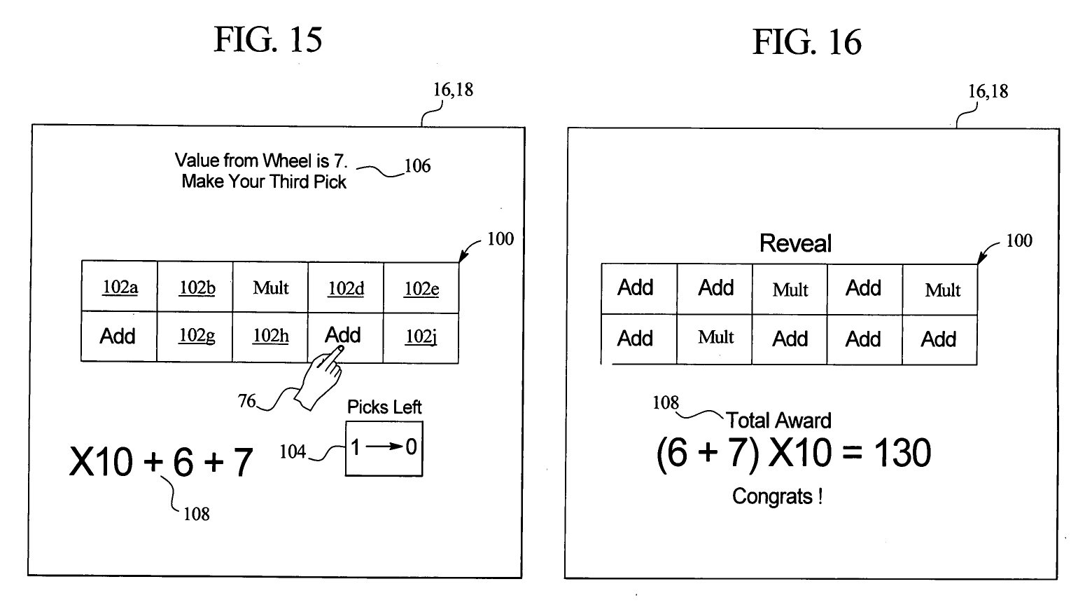

In FIG. 15 player 76 picks selection 102i. Picks remaining display 104 illustrates the player's picks decrease again from one to zero. Masked selection 102i is revealed to show an addition operation. The addition operation is associated with the value determined from the outcome generation display device, which message 106 indicates is the value seven. Interactive display 108 is updated to show a ×10, +6 and +7.

FIG. 16 shows grid 100 fully revealed. Revealed grid 100 illustrates the percent loading of the grid with respect to the constituent types of mathematical operations. In this embodiment, addition and multiplication are used again. As with the first primary embodiment any combination of addition, multiplication, division and/or subtraction may be used here. Message 108 shows that the addition values are added together and then multiplied by the multiplier to form a total award for the player of 130 credits.

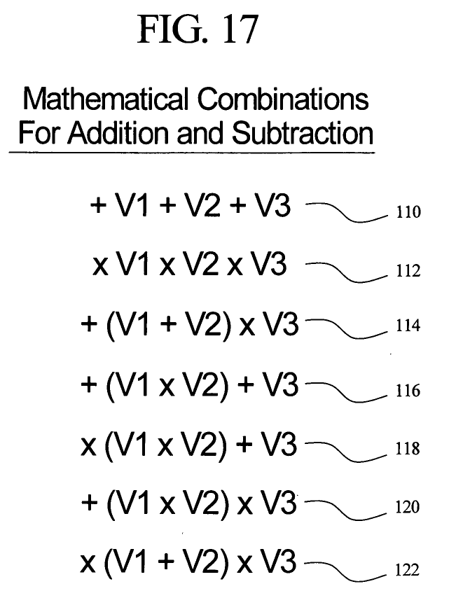

FIG. 17 illustrates various ways to combine the illustrated operation/value associations illustrated in connection with FIGS. 13 to 16. A first combination 110 is employed when each of the revealed operations is an addition operation. Combination 112 shows the outcome of three resulting multiplier operations. Combinations 114 and 116 show alternative ways of grouping two addition operations and one multiplication operation. Combinations 118, 120 and 122 show alternative ways of grouping a single addition operation and a plurality of multiplication operations. For example, combination 122 shows one possibility in which two multipliers are added together and multiplied by a single addition value.

In FIG. 17, each combination includes a same number of values as operations, e.g., three values and three operations. In another embodiment, mathematical operations are each displayed in combination with a pair of values, so that one less operation than value is displayed. For example, if three values are displayed, the possible combinations may be as follows: (i) value+value+value; (ii) (value+value)×value; (iii) (value×value)+value; and (iv) value×value×value.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A gaming device controlled by a processor, the gaming device comprising:
an outcome display, the outcome display and processor operable to display to a player a plurality of values generated from a set of a plurality of values;
a display device, the display device and processor operable to display a plurality of selections to the player, at least one of the selections being configured to (i) result in a termination of further play when generated, and (ii) to yield one of a plurality of different mathematical operations; and
an award adapted to be provided to the player which is determined based on said yielded mathematical operation applied to the values generated and displayed by the outcome display.

2. The gaming device of claim 1, wherein the plurality of mathematical operations include: addition and multiplication.

3. The gaming device of claim 1, wherein the plurality of mathematical operations include: addition, multiplication, subtraction and division.

4. The gaming device of claim 1, wherein the termination of further play includes a termination of further picks of the selections by the player.

5. The gaming device of claim 1, wherein the outcome display is selected from the group consisting of: a wheel, a reel, and a video monitor.

6. The gaming device of claim 1, wherein the values are placed in first and second groups, and wherein the selections reveal whether each value is placed into the first group or the second group.

7. The gaming device of claim 6, wherein values placed in the first group are summed to form a first sum and the values placed in the second group are summed to form a second sum, and wherein the mathematical operation is applied to the first and second sums.

8. The gaming device of claim 1, wherein the selections are divided into rounds, and wherein each non-final round is configured to provide the player at least one pick from the selections displayed in the round after which the player advances to a next round unless the selection picked results in the termination of further play.

9. The gaming device of claim 8, wherein a likelihood of picking one of the selections resulting in the termination of further play increases in later played rounds.

10. The gaming device of claim 8, wherein a final round includes only selections resulting in the termination of further play.

11. The gaming device of claim 8, wherein a final round includes at least one selection configured to return play to an earlier round.

12. The gaming device of claim 8, wherein at least one initial round includes no selections resulting in the termination of further play.

13. The gaming device of claim 1, wherein the outcome display is configured to be initiated by the player to display the generated values.

14. The gaming device of claim 1, wherein the outcome display is configured to automatically display the generated values.

15. The gaming device of claim 1, wherein the processor is operable to enable the outcome display to display the generated values before one of the selections is picked.

16. A gaming device controlled by a processor, the gaming device comprising:
a display device, said display device and processor operable to display a plurality of selections to a player;
an outcome display, said outcome display and processor operable to generate and display a plurality of outcomes, wherein picking of the selections causes the plurality of outcomes generated and displayed by the outcome display to be placed into one of at least two groups of outcomes;
a plurality of different mathematical combinations; and
an award adapted to be provided to the player, the award based on an application of one of the mathematical combinations to the outcomes accumulated in at least two of the groups.

17. The gaming device of claim 16, wherein the outcome display is displayed by the display device with the selections.

18. The gaming device of claim 16, wherein the outcome display is positioned separately from the display device and the selections.

19. The gaming device of claim 16, wherein the outcomes in each group are summed and the mathematical combination is applied to the summed outcomes.

20. The gaming device of claim 19, wherein one of the selections when picked by the player determines which of said mathematical operations is applied to the summed outcomes.

21. The gaming device of claim 16, wherein the mathematical combinations include addition and multiplication.

22. The gaming device of claim 16, wherein the mathematical combinations include addition, multiplication, subtraction and division.

23. The gaming device of claim 16, wherein the selections are placed into rounds, each non-final round configured to provide the player at least one pick from the selections displayed in the round, after which the player advances to a next round unless the selection picked terminates further play.

24. The gaming device of claim 23, wherein the selection that terminates further play also determines the mathematical operation applied to the outcomes.

25. A gaming device operable under control of a processor, the gaming device comprising:
a first display device controlled by the processor and operable to display a plurality of generated values;
a second display device controlled by the processor and operable to display a generated one of a plurality of different mathematical operations, each mathematical operation generated in association with one of the generated values; and
an award adapted to be provided to a player, said award formed based on at least three generated values displayed by the first display device and at least two of the generated mathematical operations displayed by the second display device.

26. The gaming device of claim 25, wherein the mathematical operations include addition and multiplication.

27. The gaming device of claim 25, wherein the mathematical operations include addition, multiplication, subtraction and division.

28. The gaming device of claim 25, wherein the first display device is selected from the group consisting of: a wheel, a reel, and a video monitor.

29. The gaming device of claim 25, wherein the second display device includes a plurality of selections that when selected by a player each reveal one of the mathematical operations.

30. The gaming device of claim 25, wherein the first display device generates three values and wherein the award is formed via one of the combinations selected from the group consisting of: (i) value+value+value (ii) (value+value)×value, (iii) (value×value)+value, and (iv) value×value,×value.

31. The gaming device of claim 25, wherein the processor is operable to: (i) enable one of the values to be displayed first and then enable its associated mathematical operation to be displayed, or (ii) enable a mathematical operation to be displayed first and then enable is associated value to be displayed.

32. The gaming device of claim 25, which includes (i) a mathematical operation displayed in association with each displayed value, or (ii) one less mathematical operation displayed than a number of values displayed.

33. A method of operating a gaming device, the method comprising:
displaying a plurality of values;
enabling a player to pick a plurality of selections;
placing the displayed values in at least two displayed groups based on outcomes from the picked selections until a selection is picked that reveals a terminator;
combining at least two of the groups of values according to at least one mathematical operation selected from a plurality of different mathematical operations, wherein the selected mathematical operation is provided in association with the terminator; and
providing an award to the player, the award based on a result from the combined groups of values.
